(19) United States
(12) Patent Application Publication
(10) Pub. No.: US 2006/0088658 A1
(43) Pub. Date: Apr. 27, 2006

(54) Dry treatment method for decreasing contact angle on an optical film surface

(75) Inventors: Jui-Chi Wu, Taoyuan (TW); Ming-Chih Shih, Taoyuan (TW); Yao-Chung Cheng, Taoyuan (TW); Chuan-Shu Wang, Taoyuan (TW); Yu-Chun Liu, Taoyuan (TW)

Correspondence Address: NIKOLAI & MERSEREAU, P.A., 900 SECOND AVENUE SOUTH, SUITE 820, MINNEAPOLIS, MN, 55402, US

(73) Assignee: OPTIMAX TECHNOLOGY CORPORATION, Taoyuan (TW)

(21) Appl. No.: 11/074,884

(22) Filed: Mar. 8, 2005

(30) Foreign Application Priority Data
Oct. 27, 2004 (TW) 093132614

(51) Int. Cl. B05D 5/06

(52) U.S. Cl. 427/162

(57) ABSTRACT

A dry treatment method for decreasing contact angle on an optical film surface, includes providing an optical film and subjecting the optical film to ozone treatment to increase hydrophilic groups on a surface of the optical film so as to decrease contact angle on the optical film surface. The optical film treated with ozone will increase hydrophilic groups on the surface of the optical film to decrease its contact angle thereon. This method is able to reduce disadvantage of higher expense and inconvenient use in prior art of wet method.

### BACKGROUND OF THE INVENTION

1. Field of the Invention

The present invention relates to a method for decreasing contact angle on an optical film surface, and more particularly to a dry treatment process for decreasing contact angle on an optical film surface by utilizing ozone.

2. Description of Related Art

A polarizer is an indispensable component for liquid crystal display device such as Twisted Nematic LCD, Super Twisted Nematic LCD, and Thin Film Transistor LCD. With LCD industry booming, the demand for polarizer becomes large. The polarizer functions as a filter with reference to the polarization of light. In a LCD device, two polarizers are respectively orthogonal with respect to polarizing orientation thereof, disposed on the opposite sides of the liquid crystal unit. By adjusting the voltage on the conductive substrates sandwiching the liquid crystal to change the liquid crystal arrangement, one can control the light transmittance out of the polarizer.

The polarizer is constituted of multiple films, wherein polyvinyl alcohol is usually used as a polarizing element. After the polyvinyl alcohol has been stretched as a polyvinyl alcohol film, two optical films made of such as triacetate cellulose are usually laminated on the opposite sides of the polyvinyl alcohol film to protect and prevent the polyvinyl alcohol film from shrinking.

In manufacturing the polarizer, it is found that if the contact angle of hydrophilic liquid on the optical film surface is over 40 degree, the laminating process of the polyvinyl alcohol film on the optical film is easy to fail. Conventionally, for example, the pre-treatment process for the triacetate cellulose film for decreasing the contact angle of hydrophilic liquid thereon comprises the following steps of:

washing the original triacetate cellulose film with alkaline chemical compound for a predetermined time;

washing the triacetate cellulose film with pure water to clean the alkaline chemical compound residue thereon;

washing the triacetate cellulose film with sulfuric acid;

washing the triacetate cellulose film with pure water to clean the sulfuric acid residue thereon;

drying the triacetate cellulose film in a vacuum oven.

By these above-mentioned steps, the triacetate cellulose film is able to increase its surface hydrophilic capability to decrease contact angle thereon so as to facilitate the lamination process for the polyvinyl alcohol film and the triacetate cellulose.

However, the wet treatment process requires a large number of chemical compounds, such as alkaline chemical compounds and acid chemical compounds, strict inspection on various parameters, such as temperature, concentration, etc., in each step is required. The recycle of waste liquid is also required. Due to the several wet steps, the pipe arrangements of the devices become very complex. In brief, the wet process is costly and inconvenient.

### SUMMARY OF THE INVENTION

An object of the present invention is to provide a dry treatment method for decreasing contact angle on an optical film surface by utilizing ozone. By using ultraviolet ray to irradiate oxygen in air, the oxygen molecule will split into two oxygen atoms having high activity. Then the oxygen atom collides with oxygen molecule to produce ozone having strong oxidation capability. With the strong oxidation capability, ozone is used to treat with the optical film to increase hydrophilic groups on optical film surface so as to decrease contact angle thereon.

And other object of the present invention is to provide a dry treatment process for decreasing contact angle on an optical film surface, which can reduce cost of chemical compounds and recycling waste liquid. The process also simplifies the conventional steps and need not complex pipe arrangement so as to promote convenience of use.

Other and further features, advantages and benefits of the invention will become apparent in the following description taken in conjunction with the following drawings. It is to be understood that the foregoing general description and following detailed description are exemplary and explanatory but are not to be restrictive of the invention.

### BRIEF DESCRIPTION OF THE DRAWINGS

FIG. 1 is a result table of contact angle on triacetate cellulose film surface after treatment according to the present invention.

### DETAILED DESCRIPTION OF THE PREFFERED EMBODIMENT

The dry treatment process by utilizing ozone in accordance with the present invention can deal with any optical film that is conventionally treated by wet process in prior art, such as made of triacetate cellulose, diacetate cellulose, cellulose acetate butyrate, polycarbonate, olefin copolymer, cyclic olefin copolymer, styrene resin, acrylonitrile resin, polyester resin, polysulfone, polyethersulfone, etc., or combination thereof.

Chemically, ozone has a very high active property. It is a strong oxidant and easy to self decompose to become oxygen. In normal conditions ozone is not easy to exist in normal environment for a long time. The self-decomposition rate of ozone varies with heat, light, pH value, and other parameters. Some metal oxides and catalysts also can increase the ozone self-decomposition rate. Ozone decomposition process comprises a series of the reactions. One product of one reaction may react with any other products of different reactions. The decomposition process is complex.

Nowadays there are two main methods to produce artificial ozone: one is corona-discharging technology; the other is violet-irradiating technology. Use of corona-discharging method not only produces ozone but also nitrogen oxides (NOₓ) that are harmful to human if reacting with water or moisture in the air to become nitrous acid. On the other hand, violet-irradiating method is by using violet ray to irradiate oxygen in air to produce ozone in photochemical reaction and does not produce nitrogen oxides.

In a preferred embodiment of the present invention, violet ray generated by a low-pressure mercury lamp irradiates oxygen molecule to split the oxygen molecule into two oxygen atoms having strong activity. Then the oxygen atom collides with oxygen molecule to produce ozone having strong oxidation capability. All the chemical reactions are depicted as follows:
O₂+hr (185 nm)→O (³P)+O (³P)
O₂+O (³P)→O₃
O₃+hr (254 nm)→O₂+O (¹D)
   Ozone is also easy to be self-decomposed,
O₃→O₂+O (³P)
   wherein O (¹D) represents active oxygen atom in excited state, O (³P) represents oxygen atom in ground state, and hr represents ultraviolet ray with different wave length in parentheses. Ozone produced is used to treat the optical film with its strong oxidation capability so as to increase hydrophilic groups on the optical film surface to decrease contact angle thereon.

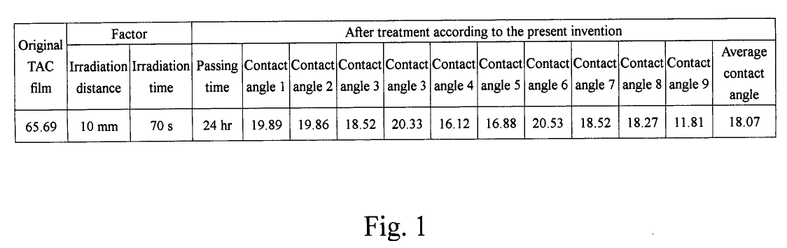

With reference to FIG. 1 taking the triacetate cellulose film as an example, before the triacetate cellulose film was treated by dry treatment process of the present invention, contact angle on the triacetate cellulose film surface is 45.69 degree. After the triacetate cellulose film was treated by the dry treatment process, in which the triacetate cellulose film was 10 mm away from the low-pressure mercury lamp and irradiated during 70 seconds, the contact angle decreased, even though passing 24 hours the average contact angle was 18.07 degree.

Therefore, use of the dry ozone treatment process of the present invention ensures the decreasing of contact angle of the optical film and also reduces cost of chemical compounds and recycling waste liquid. The process also simplifies the conventional steps and need not complex pipe arrangement so as to promote convenience of use.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A dry treatment method for decreasing contact angle on an optical film surface, comprising the step of:
subjecting an optical film to ozone treatment to increase hydrophilic groups on a surface of the optical film so as to decrease contact angle of hydrophilic liquid on the optical film surface.

2. The dry treatment method for decreasing contact angle on optical film surface according to claim 1, wherein the optical film is selected from the group consisting of triacetate cellulose, diacetate cellulose, cellulose acetate butyrate, polycarbonate, olefin copolymer, cyclic olefin copolymer, styrene resin, acrylonitrile resin, polyester resin, polysulfone, polyethersulfone, and combination thereof.

3. The dry treatment method for decreasing contact angle on optical film surface according to claim 1, wherein the ozone is produced by a photochemistry reaction in which ultraviolet ray irradiates oxygen.

4. The dry treatment method for decreasing contact angle on optical film surface according to claim 2, wherein the ozone is produced by a photochemistry reaction in which ultraviolet ray irradiates oxygen.

5. The dry treatment method for decreasing contact angle on optical film surface according to claim 3, wherein the ultraviolet ray is generated by at least one low-pressure mercury lamp.

6. The dry treatment method for decreasing contact angle on optical film surface according to claim 4, wherein the ultraviolet ray is generated by at least one low-pressure mercury lamp.

7. A dry treatment method for decreasing contact angle on an optical film surface, comprising the step of:
providing an optical film;
subjecting the optical film to ozone treatment to increase hydrophilic groups on a surface of the optical film so as to decrease contact angle of hydrophilic liquid on the optical film surface.

8. The dry treatment method for decreasing contact angle on optical film surface according to claim 7, wherein the optical film is selected from the group consisting of triacetate cellulose, diacetate cellulose, cellulose acetate butyrate, polycarbonate, olefin copolymer, cyclic olefin copolymer, styrene resin, acrylonitrile resin, polyester resin, polysulfone, polyethersulfone, and combination thereof.

9. The dry treatment method for decreasing contact angle on optical film surface according to claim 7, wherein the ozone is produced by a photochemistry reaction in which ultraviolet ray irradiates oxygen.

10. The dry treatment method for decreasing contact angle on optical film surface according to claim 8, wherein the ozone is produced by a photochemistry reaction in which ultraviolet ray irradiates oxygen.

11. The dry treatment method for decreasing contact angle on optical film surface according to claim 9, wherein the ultraviolet ray is generated by at least one low-pressure mercury lamp.

12. The dry treatment method for decreasing contact angle on optical film surface according to claim 10, wherein the ultraviolet ray is generated by at least one low-pressure mercury lamp.
